(19) United States
(12) Patent Application Publication
(10) Pub. No.: US 2021/0006530 A1
(43) Pub. Date: Jan. 7, 2021

(54) Social Networking Service for Sharing Recordings of Phone Calls

(71) Applicant: Assaf Bivas, Pardes Hana Karkur (IL)

(72) Inventor: Assaf Bivas, Pardes Hana Karkur (IL)

(21) Appl. No.: 16/459,617

(22) Filed: Jul. 2, 2019

(51) Int. Cl. H04L 12/58; H04M 3/42; H04L 29/08

(52) U.S. Cl. CPC H04L 51/32; H04L 51/10; H04L 67/306; H04M 3/42221

(57) ABSTRACT

A method for a social networking service for sharing recordings of phone calls performed by a processing device running on an internet device. The method enables a user of the internet device to open an account and to be identified by a user account, enables the user to conduct the phone call with a participant by the phone call service, enables the recording of the phone call by a recording system, enables the sending to the participant a digital notification for asking permission to upload the recording to the account of the user, enables the participant to send the permission as a digital file that is stored and tagged into the recording or the processing device, and enables the user to tag the recording by hashtag.

### TECHNICAL FIELD

The present invention refers to a method for a social networking service for sharing recordings of phone calls.

### BACKGROUND ART

In many cases, a person may want to share with others recordings of his phone calls and to enable them to listen to these recordings. In the same way many people may be interested to listen to recordings of phone calls of other people. The interest in sharing or listening to recordings of phone calls of others can be a result of mere snooping or professional or personal reasons.

For example, a patent lawyer conducts many phone calls with his clients in which he provides general explanations about patent laws and practices, such as, why it is important to register a patent, what is the difference between a patent application and a provisional application, how to decide whether an invention in non-obvious, and many other professional interesting topics. If this patent lawyer will have the recordings of his phone calls then he may upload them to an online database, when he has the consent of the other party of that talk, and enable other clients or potential clients to listen to these recordings for getting useful information.

Another example, a person that records his phone calls with his girlfriend or wife in which they discuss all their private matters and enables other people to listen to these recordings for getting nosy satisfaction. These two examples are at the edges, snooping and a desire to receive important professional knowledge, and between them there is a broad spectrum of interests. Making such recordings of phone calls and uploading them to a social media service requires methods that are designed to overcome technical and legal issues.

The present invention discloses an effective solution for these needs by providing a method that is in fact a web platform that serves as social media for executing such recordings, receiving the consent of the participants of these phone calls, uploading and tagging these recordings.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that illustrates two internet devices (20) of a user (20A) and of a participant (20B), each of them includes a processing device (10), and a server (100) with a processing device (30).

### THE INVENTION

The main object of the present invention is to provide a method performed by a processing device (10) that is designed to enable a user of internet device (20) to create a user account, to record his phone calls with other people, to send a notification to the participants of the phone calls for receiving from them a permission to maintain the recordings and to upload them to his account. The method subject matter of the present invention is in fact a social networking service of sharing recordings of phone calls. The term “internet device” (20) in the present patent application and in the claims refers to any kind of device which is designed to have internet connection, such as smartphones, computers, tablets and the like.

A web platform such as a computer program or a mobile application may be used as a framework for the overall operation and use of the method and for the sake of fluency we will use the terms “web platform” and “method” hereinafter in this connection and as having in general the same meaning. A user of an internet device (20) may download the web platform which is performed by the processing device (10) of the internet device (20), and may be also performed by a processing device (30) in a server (100).

The method includes a phone call service (40). The phone call service may be a VoIP service that may be an independent VoIP service and/or may employ the existing VoIP services such as of Telegram™, WhatsApp™, Messenger™ and the like. The phone call service may employ the cellular network service. The method enables the user to conduct a phone call over the phone call service (40) (cellular network or VoIP services). The term “phone calls” hereinafter and in the claims refers to cellular calls and/or VoIP calls.

The method enables a user to create an account and to upload to his account recording of his phone call with a participant.

The method sends to the participant of the phone call a notification in the end of that phone call, or in other time, for receiving his permission to the user to maintain the recording of their phone call and to upload it to the user's account.

The method enables the user to upload to his account the recording of the phone call after receiving the permission from the participant of that phone call and enables the users to tag the recording by hashtag, means, to tag the recording according to categories and subcategories for enabling other to search and find the recording according such key words.

The recordings in the account can be shared publicly or with pre-approved followers. Users can browse other users' recordings by tags. Users can “like” recordings, and follow other users to add their content to a feed, in the same manner as of the Instagram™ social networking service. The method also enables the user to add recordings as a ‘story’ to a sequential feed, similar to Instagram™ and Snapchat™.

The method enables users to follow other users' feeds. The Users can set their account as “private”, thereby requiring that they approve any new follower requests. Users can connect their account to other social networking sites, enabling them to share uploaded recordings to those sites.

A person can download the web platform to his internet device, which may be his or her mobile phone. The person can open an account, and upload recording of his or her phone calls. The account of the user may include many recordings that can be arranged and sorted by subjects and categories.

In the example where the registered user is a patent lawyer, his or her account may include dozens or even hundreds of recordings of phone calls that he or she has conducted with clients and colleagues who of course have given their permission for such use. A great deal of knowledge may be accumulated and can serve as a basis for the search of information by the general public. Another example could be a psychologist that conducts phone calls with patients about child care, conversations with a chef about cooking. It also seems that many people will be curious to listen also to recordings of phone calls from other people talking about very personal matters. Each user may have an account, similar to his or her Instagram account, without photons but simply with recordings of his or her phone calls.

When a user see that he or she is going to have a phone call that may be worthy to be recorded and uploaded to his or her account, then the user can ask the participant an advanced consent to record the phone call for his account and if the participant agrees then they can conduct the phone call through the method for receiving the posterior digital permission from the participant and to tag this digital permission to the recording or to store it in the processing device.

In summary, the method for a social networking service for sharing a recording of a phone call performed by a processing device running on an internet device, may include the following steps and features:

(a) The method enables a user of the internet device to open an account and to be identified by his or her user account.

(c) The method enables the user to conduct a phone call with a participant by the phone call service (40) that may be an existing VoIP service, cellular networking service or independent built-in VoIP service.

(d) The method records the phone call by a recording system (50) that can be the existing recording system that is built-in the internet device of the user or by an independent recording system that may be a part of the method.

(e) The method sends to the participant of said phone call a digital notification for asking permission from the participant to the user to upload the recording of their phone call to the account of the user.

(f) The method enables the participant to send said permission as a digital file that is stored and tagged into the recording, the processing device of the internet device of the user or the processing device in the server.

(g) The method enables the user to tag the recording by hashtag.

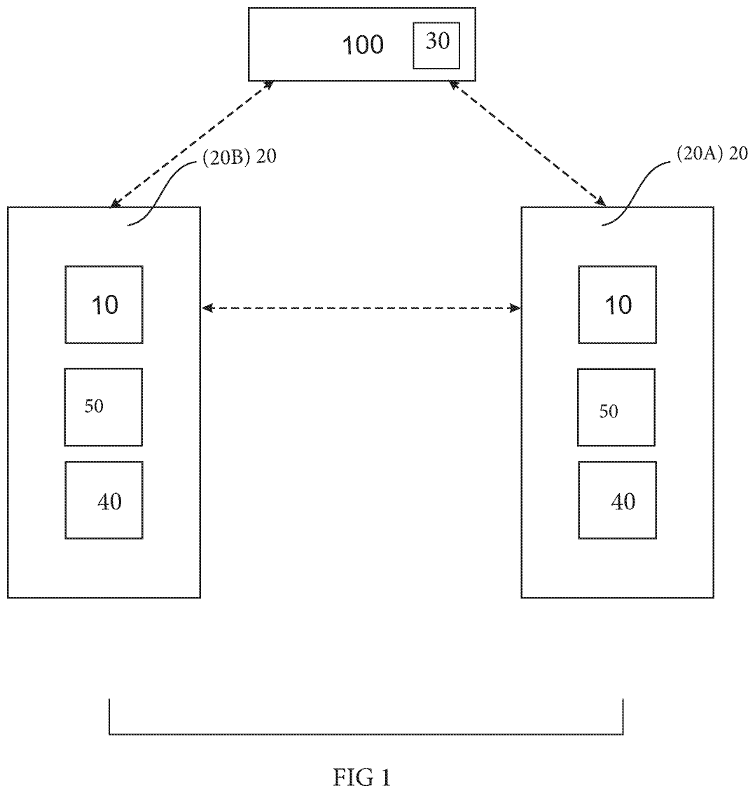

FIG. 1 is a block diagram that illustrates two internet devices (20) of a user (20A) and of a participant (20B), each of them includes a processing device (10), and a server (100) with a processing device (30).

What is claimed is:

1. A method for a social networking service for sharing a recording of a phone call performed by a processing device running on an internet device, comprising:
(a) enabling a user of the internet device to open an account and to be identified by a user account;
(c) enabling the user to conduct the phone call with a participant by a phone call service;
(d) recording said phone call by a recording system;
(e) sending to the participant of said phone call a digital notification for asking permission from the participant to the user to upload the recording of said phone call to the account of the user;
(f) enabling the participant to send said permission as a digital file that is stored and tagged with connection to the recording, the processing device of the internet device of the user or the processing device in a server; and
(g) enabling the user to tag the recording by hashtag.
